(19) United States
(12) Patent Application Publication
(10) Pub. No.: US 2005/0062680 A1
(43) Pub. Date: Mar. 24, 2005

(54) Method and apparatus for compensating for difference in picture quality caused by burn-in effect on screen of display device

(75) Inventors: Jung-won Lee, Ansan-si (KR); Kang-suk Lee, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/909,837

(22) Filed: Aug. 3, 2004

(30) Foreign Application Priority Data
Aug. 4, 2003 (KR) 03-53878

(51) Int. Cl. G09G 1/06

(52) U.S. Cl. 345/10

(57) ABSTRACT

A method and apparatus for compensating for a difference in picture quality caused by a burn-in effect on a screen of a display device are provided. The apparatus for compensating for the difference in the picture quality includes: an A/D conversion unit providing digitalized picture information by converting an analogue picture signal; a compensation area setting unit setting up area to be compensated for the difference in picture quality caused by the burn-in effect according to the picture information provided; a screen compensation processing unit adjusting at least one of brightness and contrast according to the picture information provided so as to balance an entire screen by decreasing the difference in picture quality caused by the burn-in effect; and a picture output unit outputting a picture signal generated by converting the picture information adjusted into the picture signal.

### CROSS REFERENCE TO RELATED APPLICATIONS

This application claims the priority of Korean Patent Application No. 2003-53878, filed on Aug. 4, 2003, in the Korean Intellectual Property Office, the disclosure of which is incorporated herein in its entirety by reference.

### BACKGROUND OF THE INVENTION

1. Field of the Invention

The present invention relates to a display device, and more particularly, to a method and apparatus of compensating for a difference in picture quality caused by a burn-in effect on a screen of the display device.

2. Description of the Related Art

In a display device such as a projection, images undergo a burn-in effect due to the use of a cathode-ray tube (CRT). The burn-in effect occurs in a case where an area in which images are continuously projected, includes a damaged fluorescent substance, and thus has a different brightness compared to an area in which images are not projected.

Accordingly, if the images are continuously projected on the same area, picture quality of that area is different from other areas. For instance, if a 4:3 screen has been projected for an extended period of time, a difference in picture quality occurs between an external area of the 4:3 screen in which the images are not projected and the burn-in effect hardly occurs, and an internal area of the 4:3 screen in which the images are continuously projected and the burn-in effect occurs relatively often. The difference in picture quality caused by the burn-in effect is a common problem in the display device having the CRT.

Existing methods to solve this problem focus on preventing the occurrence of a burn-in effect. However, it is impossible to completely prevent its occurrence, and furthermore, the difference in picture quality caused by the burn-in effect is inevitably caused as time passes.

In addition, a conventional method to prevent the burn-in effect occurring in an entire screen cannot be applied to prevent the burn-in effect from occurring in part of the screen.

### SUMMARY OF THE INVENTION

Illustrative, non-limiting exemplary embodiments of the present invention overcome the above disadvantages, and other disadvantages not described above.

A method and apparatus consistent with the present invention provides for compensating for a difference in picture quality caused by a burn-in effect on a screen of a display device, according to a user's desired means or automatically.

Thus, the present invention reduces the deleterious effects of the difference in picture quality on the final screen caused by the burn-in effect.

According to an aspect of the present invention, there is provided an apparatus for compensating for a difference in picture quality caused by a burn-in effect on a screen of a display device, the apparatus including: an A/D conversion unit providing digitalized picture information by converting an analogue picture signal; a compensation area setting unit setting up area to be compensated for the difference in picture quality caused by the burn-in effect according to the picture information provided; a screen compensation processing unit adjusting at least one of brightness and contrast according to the picture information provided so as to balance an entire screen by decreasing the difference in picture quality caused by the burn-in effect; and a picture output unit outputting a picture signal generated by converting the picture information adjusted into the picture signal.

Preferably, but not necessarily, the compensation area setting unit sets up the compensation area by receiving locational information on the screen from a user, that is needed to compensate for the difference in picture quality or automatically searching an area having the difference in picture quality, caused by the burn-in effect.

Preferably, but not necessarily, the compensation area setting unit outputs the screen in a single color so as to easily search the area having the difference in picture quality caused by the burn-in effect.

According to another aspect of the present invention, there is provided a method of compensating for a difference in picture quality caused by a burn-in effect on a screen of a display device, the method including: setting a compensation area having the difference in picture quality among the entire screen; adjusting at least one of brightness and contrast according to the picture information of the compensation area so as to balance the entire screen by decreasing the difference in picture quality caused by the burn-in effect; and outputting the picture signal generated by converting the picture information adjusted into the picture signal.

Preferably, but not necessarily, the setting of the compensation area further includes: outputting the screen in a single color so as to easily search the area having the difference in picture quality caused by the burn-in effect; and setting up the compensation area by receiving locational information on the portion that needs to be compensated for in response to the difference in picture quality selected by a user or automatically searching an area having the difference in picture quality caused by the burn-in effect, based on the test screen that is output.

A computer readable medium having embodied thereon a computer program for the aforementioned method may achieve the purpose of the present invention.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of an apparatus for compensating for a difference in picture quality caused by a burn-in effect according to an embodiment of the present invention;

FIG. 2 is a flow chart illustrating a method of compensating for a difference in picture quality caused by a burn-in effect according to an embodiment of the present invention;

FIG. 3 is a detailed flow chart illustrating a method of setting up a compensation area (A) in FIG. 2; and

FIG. 4 is a detailed flow chart illustrating a method of compensating for a difference in picture quality (B) in the compensation area (A) set up in FIG. 2

### DETAILED DESCRIPTION OF THE EXEMPLARY EMBODIMENTS OF THE PRESENT INVENTION

The present invention will now be described more fully with reference to the attached drawings, in which exemplary embodiments of the invention are shown.

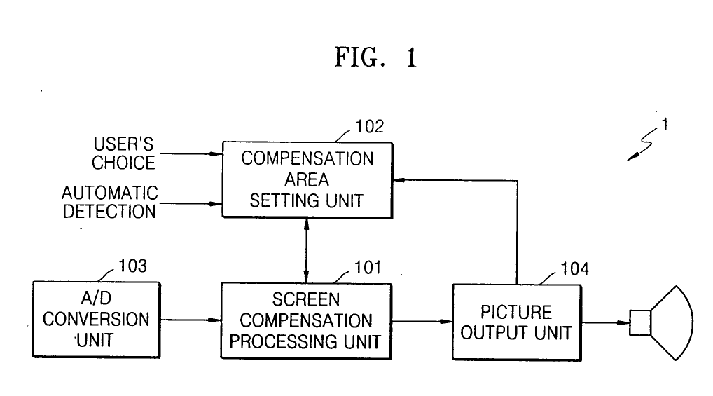

FIG. 1 is a block diagram of an apparatus for compensating for a difference in picture quality caused by a burn-in effect according to an embodiment of the present invention.

Referring to FIG. 1, an apparatus 1 for compensating for the difference in picture quality caused by the burn-in effect includes an A/D conversion unit 103, a compensation area setting unit 102, a screen compensation processing unit 101, and a picture output unit 104.

The AND conversion unit 103 provides digitalized picture information by converting an analogue picture signal. Digitalized picture information includes brightness, contrast, or color values of each pixel.

The compensation area setting unit 102 sets up an area that needs to be compensated for with respect to the difference in picture quality caused by the burn-in effect (hereinafter “compensation area”) according to the picture information provided from the A/D conversion unit 103. Specifically, the compensation area setting unit 102 sets up the compensation area by receiving locational information on a screen from a user, that needs to be compensated for due to a difference in picture quality, or automatically searching an area having a difference in picture quality caused by the burn-in effect. That is, the user can set up the compensation area for any desired area, or automatically. The compensation area setting unit 102 also outputs the screen in a single color so that the area having the difference in picture quality caused by the burn-in effect can be easily searched.

For example, if a 4:3 screen has been projected for an extended period of time and a difference in picture quality caused by the burn-in effect occurs, an external area of the 4:3 screen, in which the relatively less burn-in effect occurs, may be set up as the compensation area.

The screen compensation processing unit 101 adjusts at least one of the brightness and the contrast regarding the picture information on the compensation area so as to balance the entire screen by decreasing the difference in picture quality caused by the burn-in effect. For instance, at least one of the brightness and the contrast in the digitalized picture information of the compensation area is gradually lowered until the entire screen is balanced, thereby removing the difference in picture quality caused by the burn-in effect.

Since the brightness and the contrast of the compensation area having relatively less burn-in effect are lowered, the picture quality thereof is almost identical to that of the area having the relatively higher burn-in effect. Thus, the user hardly recognizes the difference in picture quality caused by the burn-in effect and the same effect without the burn-in effect can be obtained.

Hereinafter, a method of compensating for the difference in picture quality caused by the burn-in effect according to an embodiment of the present invention will be explained, based on the aforementioned structure.

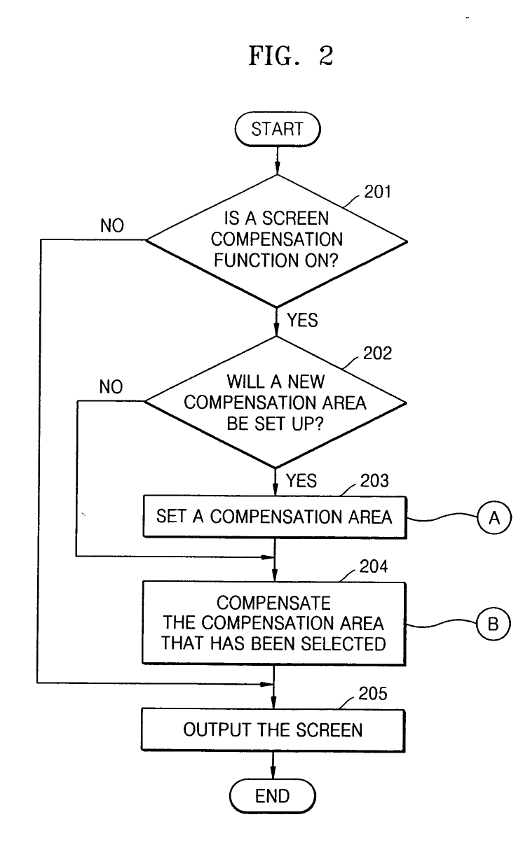

FIG. 2 is a flow chart illustrating a method of compensating for a difference in picture quality caused by a burn-in effect according to an embodiment of the present invention.

Referring to FIG. 2, so as to compensate for the difference in picture quality on a screen of a display device, it is first checked whether a screen compensation function is on in step 201. In a case where the screen compensation function is off, the original screen is output in step 205. However, in a case where the screen compensation function is on, selection information on whether a new compensation area will be set up is checked in step 202. If the new compensation area is not to be set up, the compensation area that has been selected is compensated in step 204, and the compensated screen is converted into an analogue picture signal, and the signal is output in step 205. If the new compensation area is to be set up, the compensation area is set up according to the user's choice, or automatically, in step 203. Then, at least one of the brightness and the contrast in the digitalized picture information of the compensation area is adjusted until the entire screen is balanced and no difference in picture quality caused by the burn-in effect is present in step 204, and the compensated screen is converted into the analogue signal, and the signal is output in step 205.

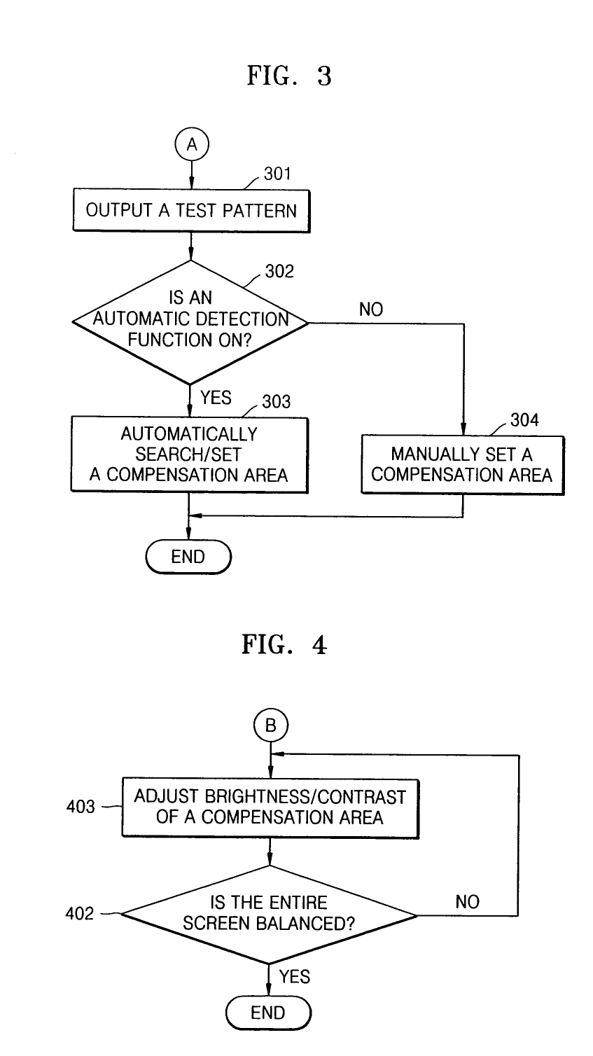

FIG. 3 is a detailed flow chart illustrating a method of setting up a compensation area (A) in FIG. 2.

Referring to FIG. 3, the screen in a single color is output so as to easily search the area having the difference in picture quality caused by the burn-in effect in step 301 and whether a function of automatic detection is on or off is decided in step 302. If the automatic detection function is on, the compensation area is set up by automatically searching the area having the relatively lesser burn-in effect, that is, the area having a value of brightness relatively larger than a fixed value when compared with those of other areas, by using a test screen output in step 303.

However, if the function of automatic detection is off, the compensation area is set up based on the selection information on the compensation area provided by the user in step 304. The user can locate the area having the difference in picture quality caused by the burn-in effect by using the test screen in a single color output.

FIG. 4 is a detailed flow chart illustrating a method of compensating for a difference in picture quality (B) in the compensation area (A) set up in FIG. 2.

Referring to FIG. 4, at least one of the brightness and the contrast among the digitalized picture information in the compensation area is gradually adjusted step by step in step 401. In step 402, it is decided,whether the entire screen has become balanced so that there is no difference in picture quality, and if the picture quality is not below a predetermined value, a procedure of screen compensation is repeated in step 401.

In the meantime, the present invention may be embodied in a general purpose digital computer by running a program for a computer readable medium, including but not limited to storage media such as magnetic storage media (e.g., ROMs, RAMs, floppy disks, hard disks, etc.), optically readable media (e.g., CD-ROMs, DVDs, etc.), and carrier waves (e.g., transmissions over the internet). In addition, the present invention may be embodied as a computer readable medium having a computer readable program code unit embodied therein for allowing a number of computer systems connected via a network to effect distribution processing.

As described above, the present invention is able to achieve a fully balanced screen by compensating for the difference in picture quality caused by the burn-in effect on the screen of the display device. That is, the present invention has an advantage in compensating for the difference in picture quality, and thus, a user does not recognize the difference in picture quality caused by the partial burn-in effect due to automatic searching of the area having the relatively lesser burn-in effect or due to the user's choice and thereafter lowering the brightness and the contrast. Therefore, the user can watch a balanced screen without the partial burn-in effect.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. An apparatus for compensating for a difference in picture quality caused by a burn-in effect on a screen of a display device, the apparatus comprising:
an A/D conversion unit providing digitalized picture information by converting an analog picture signal;
a compensation area setting unit for setting up an area to be compensated for the difference in picture quality caused by the burn-in effect according to the picture information provided;
a screen compensation processing unit adjusting at least one of brightness and contrast according to the picture information provided so as to balance an entire screen by decreasing the difference in picture quality caused by the burn-in effect; and
a picture output unit outputting a picture signal generated by converting the picture information adjusted into the picture signal.

2. The apparatus of claim 1, wherein the compensation area setting unit sets up the compensation area by receiving locational information on the screen from a user, that is needed to compensate for the difference in picture quality, or automatically searching an area having the difference in picture quality, caused by the burn-in effect.

3. The apparatus of claim 2, wherein the compensation area setting unit outputs the screen in a single color so as to easily search the area having the difference in picture quality caused by the burn-in effect.

4. A method of compensating for a difference in picture quality caused by a burn-in effect on a screen of a display device, the method comprising:
setting a compensation area having the difference in picture quality among an entire screen;
adjusting at least one of brightness and contrast according to picture information of the compensation area so as to balance the entire screen by decreasing the difference in picture quality caused by the burn-in effect; and
outputting the picture signal generated by converting the picture information adjusted into the picture signal.

5. The method of claim 4, wherein setting the compensation area further comprises:
outputting the screen in a single color so as to easily search the area having the difference in picture quality caused by the burn-in effect; and
setting up the compensation area by receiving locational information on the portion that needs to be compensated for in response to the difference in picture quality selected by a user or automatically searching an area having the difference in picture quality caused by the burn-in effect, based on the test screen that is output.

6. A computer readable medium having embodied thereon a computer program for the method according to claim 4.

7. A computer readable medium having embodied thereon a computer program for the method according to claim 5.
